(19) United States
(12) Patent Application Publication
(10) Pub. No.: US 2010/0205573 A1
(43) Pub. Date: Aug. 12, 2010

(54) LAYOUT MODIFICATION ENGINE FOR MODIFYING A CIRCUIT LAYOUT COMPRISING FIXED AND FREE LAYOUT ENTITIES

(75) Inventors: Natalino Giorgio Busa, Helmond (NL); Elisabeth Johanna Eichhorn, Riethoven (NL); Jozefus Godefridus Gerardus Pancratius Van Gisbergen, Hilvarenbeek (NL); Jeroen Pieter Frank Willekens, Eindhoven (NL)

Correspondence Address: NIXON & VANDERHYE, PC, 901 NORTH GLEBE ROAD, 11TH FLOOR, ARLINGTON, VA, 22203, US

(73) Assignee: SAGANTIEC ISRAEL LTD., TIRAT CARMEL (IL)

(21) Appl. No.: 12/667,333

(22) PCT Filed: Jul. 4, 2008
(86) PCT No.: PCT/EP08/58648

§ 371 Date: Dec. 30, 2009

(51) Int. Cl. G06F 17/50

(52) U.S. Cl. 716/5; 716/10

(57) ABSTRACT

The invention relates to a layout modification engine (18) for modifying a circuit layout (1) comprising layout entities including a fixed layout entity and free layout entities. The layout entities are a representation of at least part of an integrated circuit, each layout entity comprises at least one layout element. The fixed layout entity is restrained to a predefined position. The layout modification engine comprises the conflict-solver for resolving conflicts between the fixed layout entity and the free layout entities. The conflict-solver comprises a layout analyzer (14) and a conflict-solving-module (16). The conflict-solving module generates a set of fixed layout elements for resolving the detected conflict. Because the layout modification engine converts the fixed layout entity into the set of fixed layout elements, the layout modification engine will encounter less conflict situations while modifying the circuit layout which reduces the processing time.

### FIELD OF THE INVENTION

The invention relates to a layout modification engine for modifying a circuit layout comprising layout entities including a fixed layout entity and free layout entities.

The invention further relates to a conflict-solver for use in the layout modification engine, to a method of modifying a circuit layout, and to a computer program product.

### BACKGROUND OF THE INVENTION

Integrated circuit layouts generally comprise layout entities wherein a set of layout entities is a representation of an integrated circuit. The entity may, for example, be a layer of an integrated circuit, or a cell representing, for example, a sub-circuit of the integrated circuit. The entity may also, for example, be a polygon, or even a boundary or corner of a polygon, or may, for example, be a cross-point of lines or a reference point of a cell. The entities comprise at least one layout element, wherein the layout element is the smallest constitutional part of the integrated circuit. The layout element, for example, may be an edge of a polygon, a center line and width of a path or a boundary of a path or polygon. The layout element may also be, for example, a corner of a polygon, a cross-point of two lines or a reference point of a cell.

Generally integrated circuit layouts comprise a plurality of layers. To produce the integrated circuit from an integrated circuit layout, the plurality of layers must be produced subsequently on a semi-conducting substrate via different lithography processes. Before the integrated circuit layout is produced on a semi-conducting substrate, the integrated circuit layout may be modified using a layout modification engine. These layout modification engines may, for example, be a compaction engine, a migration engine or a design-rule violation fixing engine. The compaction engine modifies the integrated circuit layout to reduce a footprint of the integrated circuit layout to reduce the area of the semi-conducting substrate required for producing the integrated circuit layout. The migration engine modifies the integrated circuit layout such that it may be produce using a different manufacturing process compared to the manufacturing process for which the integrated circuit layout was initially designed. The design-rule violation fixing engine checks a compliance of the current integrated circuit layout with the set of rules related to a specific manufacturing process, so called design-rules. Design rules are specific to a particular semiconductor manufacturing process. A set of design rules specifies certain geometric and connectivity restrictions between layout entities of the integrated circuit layout to account for variability in semiconductor manufacturing processes. The set of design rules is applied to the layout elements of the layout entities to generate the set of constraints. The set of constraints may, for example, be a set of equations in which variables in the equations represent locations of the layout elements of the layout entities. Different manufacturing processes typically comprise different sets of design rules. Compliance of the entities to a specific set of design rules associated with a specific manufacturing process ensures that the integrated circuit layout can be manufactured using the specific manufacturing process. When the design-rule violation fixing engine detects a non-compliance with the design-rules, the design-rule violation fixing engine modifies the integrated circuit design by repositioning layout elements of layout entities to generate substantially full compliance with the set of design-rules.

Specific integrated circuit layouts of the integrated circuit or specific sub-circuits of the integrated circuit layout are relatively sensitive to changes of the layout elements within the integrated circuit layout. For example, analog circuit layouts or analog sub-circuit layouts may function differently when a layout element has been altered by a layout modification engine. To avoid that some integrated circuit layouts or that some specific sub-circuits may be changed, some known layout modification engines allow a user to restrain specific layout entities from being altered by the layout modification engine.

A drawback of the known layout modification engine is that the processing time may be relatively long.

### SUMMARY OF THE INVENTION

It is an object of the invention to provide an improved layout modification engine for fixing layout entities in the integrated circuit design in which the processing time of the improved layout modification engine is reduced.

According to a first aspect of the invention the object is achieved with a layout modification engine for modifying a circuit layout comprising layout entities including a fixed layout entity and free layout entities. The layout entities are a representation of at least part of an integrated circuit, each layout entity comprises at least one layout element. The fixed layout entity is restrained to a predefined position and the free layout entities are allowed to move for modifying the circuit layout. The layout modification engine is arranged for restraining the fixed layout entity to the predefined position while modifying the circuit layout to substantially comply with a set of constraints. The set of constraints comprises design-rule-constraints for applying a design rule to a group of layout elements of the circuit layout. The layout modification engine comprises a conflict-solver for resolving conflicts between the fixed layout entity and the free layout entities. The conflict-solver comprises a layout analyzer for analyzing the circuit layout to detect a conflict between the fixed layout entity and the free layout entities. The conflict-solver provides the detected conflicts to a conflict-solving-module. The conflict-solving-module converts the fixed layout entity in the detected conflicts into a set of fixed layout elements. The set of fixed layout elements are generated for resolving the detected conflict. The fixed layout elements being layout elements restrained to a position.

The effect of the layout modification engine in accordance with the invention is that the layout analyzer analyzes the circuit layout to detect a conflict between the fixed layout entity and the free layout entity. Such a conflict may, for example, occur when the fixed layout entity, for example, is a fixed cell of an integrated circuit, while a free layout entity is a free layer of the integrated circuit. The layout elements in the fixed cell should be fixed. However, a sub-set of the layout elements of the fixed cell may be located in the free layer. The status of the sub-set of layout elements is undetermined and results in a conflict situation. This conflict is solved in the conflict-solver in which the fixed layout entity is converted into a set of fixed layout elements. This conversion may, for example, be done manually by an operator. Because the layout elements are the smallest constitutional elements of the integrated circuit layout, the replacement of the fixed layout entity by the set of fixed layout elements forces a decision in conflicting situations. The set of fixed layout elements is subsequently implemented in the set of constraints for fixing the position of the fixed layout elements.

The layout modification engine according to the invention actively forces the conflicting situations to be resolved before the layout modification engine solves the set of constraints to generate instructions for adapting the circuit layout. The conflict-solver converts the fixed layout entity into the set of fixed layout elements which is subsequently entered into the set of constraints. Because the layout modification engine converts the fixed layout entity into the set of fixed layout elements, the modifying step of the layout modification engine for modifying the circuit layout to comply with the set of constraints will encounter less conflict situations which will reduce the processing time of the layout modification engine.

In the known layout modification engines the set of constraints are solved while fixing the fixed layout entity to their restrained position. Adding the additional requirement that a specific layout entity must be restrained to a certain position may result in a conflict. In these known layout modification engines, these conflicts only arise during the solving of the set of constraints and during the adaptation of the circuit layout to comply with the set of constraints. This may cause the layout modification engine to fail to provide a solution to the set of constraints or may cause the layout modification engine to require an excessive amount of calculating time and power to generate a solution to the set of constraints. In the layout modification engine according to the invention, the circuit layout is analyzed to detect conflicts between the fixed layout element and the free layout elements. Actively resolving possible conflicts by converting the fixed layout entity into the set of fixed layout elements prevents that the conflict causes the layout modification engine to try to find a solution where there is no solution due to the conflict or where the solution is excessively complex due to the conflict. By providing the set of fixed layout elements to the layout modification engine, the occurrence of conflicts is reduced and the processing time of the layout modification engine required to generate a solution to the set of constraints is reduced.

Compliance with a set of constraints is generally achieved by the layout modification engine by solving the set of constraints to generate instructions for adapting the circuit layout. The set of constraints generally comprise a set of equations. Each equation comprises a mathematical representation of a constraint applied to groups of layout elements, for example, a design-rule applied to groups of layout elements. Adapting the circuit layout according to the instruction may result in moving the layout elements of the circuit layout which may result in moving the entities within the circuit layout and/or may result in reshaping entities within the circuit layout.

The integrated circuit may be a representation of a miniaturized electrical circuit, also commonly known as a chip, or may be a representation of a part of the chip. Alternatively, the integrated circuit may be a representation of a miniaturized construction, also commonly known as nanostructures, comprising, for example, mechanical nanostructures, magnetic nanostructures, chemical nanostructures and biological nanostructures.

In an embodiment of the layout modification engine, the detected conflict comprises a detected layout element being part of the fixed layout entity and being part of a free layout entity.

In an embodiment of the layout modification engine, the conflict-solver is rule-based. A benefit of this embodiment is that the rule-based conflict-solver solves the detected conflicts in a reproducible and predictable manner. Furthermore, the use of a rule-based conflict-solver minimizes manual inputs which further reduces the processing time of the layout modification engine by reducing idle time waiting for the manual inputs. The known layout modification engines typically signal conflicts during the solving of the set of constraints or provide a listing of the conflicts after the solving of the set of constraints. A user of the system has to manually inspect the (list of) conflicts and has to manually solve each individual conflict which is relatively time consuming. Furthermore, substantially identical conflicts may be solved by a user in a different manner which results in un-predictable differences within the integrated circuit. Using the rule-based conflict-solver for converting the fixed layout entities into the set of fixed layout elements reduces the manual inputs and solves the conflicts in a reproducible manner.

In an embodiment of the layout modification engine, the conflict-solver includes using additional properties of the fixed layout entities for resolving the detected conflict, and/or using a generic rule for resolving the detected conflict. For example, a first layout entity being a contact-hole comprises boundaries being free layout elements and a second layout entity being a line which comprise boundaries being fixed layout elements. The contact-hole comprises an additional property in that it should be connected to the line. As a result a conflict is detected between the free layout elements of the contact-hole and the additional property forcing the contact-hole to be connected to the fixed line. The conflict-solver of the layout modification engine according to the invention converts the boundaries of the contact-hole into fixed layout elements and adds these boundaries of the contact-hole to the set of fixed layout elements, thus solving a conflict. Alternatively, the first layout entity may, for example, be a polygon inside the second layout entity being a cell. The second layout entity may, for example, be a fixed layout entity. The layout elements of the polygon have conflicting requirements in that the layout elements of the polygon should be free due to the polygon being a free layout entity and should be fixed due to the cell being a fixed layout entity. In such a conflict situation, a general rule may be applied in which, for example, the status of the smallest layout entity is used to define the status of the conflicting layout elements. In the current situation, the polygon is part of the cell and thus the cell is a larger layout entity. Applying this general rule to the current situation results in the layout elements of the polygon being free layout elements which are free to move within the fixed cell.

In an embodiment of the layout modification engine, the conflict-solver is arranged for receiving a priority-value representing a level of importance of the required fixation of the fixed layout entity. This priority-value may, for example, be used to change a general rule in the previous example, in which the status of the smallest layout entity is used to define the status of the conflicting layout elements. When the priority-value of the polygon and the cell would be identical, the general rule may be applied resulting in the above shown result. However, if the priority-value of the smaller layout entity (being the polygon in the current example) is lower than the priority-value of the larger layout entity (being the cell in the current example), the status of the conflicting layout elements may be reversed. Using this priority-value and adding this priority-value to the general rule in the example shown above, the layout elements of the polygon would be fixed layout elements which would not be allowed to move within the fixed cell.

In an embodiment of the layout modification engine, the conflict-solver further comprises a receiver for receiving the fixed layout entity and/or for receiving the free layout entities. In a case where the receiver receives only the fixed layout entity, the remainder of the layout entities may, for example, have a default status of free layout entities. Alternatively, in a case where the receiver receives only the free layout entities, the remainder of the layout entities may, for example, have a default status of fixed layout entities.

In an embodiment of the layout modification engine, the fixed layout entity is a relatively fixed layout entity being a layout entity restrained relative to a virtual reference point, the virtual reference point being a further fixed layout entity or a further free layout entity. The position of the relatively fixed layout entity is fixed with respect to a virtual reference point which in itself may move around. This may, for example, occur when elements within a cell or within a sub-circuit of the circuit layout are restrained to a position within the cell or within the sub-circuit while the cell or sub-circuit may be moved throughout the circuit layout. The virtual reference point may be any arbitrary point in a cell or sub-circuit. Alternatively, the virtual reference point may be a cross-point of lines or an edge of a polygon.

In an embodiment of the layout modification engine, the receiver is arranged for receiving the fixed layout entity and/or for receiving the free layout entities via: a listing of fixed and/or free layout entities, and/or a selected area, all layout entities within the selected area being fixed layout entities or all layout entities outside the selected area are fixed layout entities, and/or a label of a sub-circuit within the circuit layout, all layout entities within the sub-circuit or a selection of the layout entities of the sub-circuit being fixed layout entities or free layout entities. A benefit of this embodiment is that it allows a flexible input of the fixed layout entities into the conflict-solver of the layout modification engine according to the invention. For example, a user may identify a selected area within a circuit layout, for example, by indicating a rectangle, a circle, an ellipse, a polygon or any combination of any of these selected areas in a computer representation of the integrated circuit. The receiver, for example, receives the selected area and identifies all layout entities within the selected area as fixed layout entities. Integrated circuit layouts also often comprise sub-circuits which are repeated at several locations within the integrated circuit layout. The receiver is arranged for receiving the label of the sub-circuit for receiving the fixed layout entities. The receiver may, for example, identify all layout entities within the sub-circuit as fixed layout entities or may only identify a selection of the layout entities within the sub-circuit as fixed layout entities. This embodiment enables the layout modification engine according to the invention to solve a conflict within the sub-circuit only once and re-apply the solution to the conflict every time the sub-circuit is placed within the circuit layout.

In an embodiment of the layout modification engine, the conflict-solver further comprises a constraint adapter for adapting the set of constraints to fix a position of the set of fixed layout elements. A benefit of this embodiment of the conflict-solver is that the conflict-solver may be used in combination with the known layout modification engine without the known layout modification engine requiring adaptation. The conflict-solver adapts the set of constraints which is subsequently used by the known layout modification engine for solving the set of constraints to generate a set of instructions indicating how to adapt the integrated circuit layout to substantially obtain compliance or to obtain best compliance with the set of constraints.

In an embodiment of the layout modification engine, the constraint adapter is arranged for fixing the position of the adapted set of fixed layout elements via converting variables representing a layout element in the set of constraints into constant values representing the predefined position assigned to the fixed layout element, or by adding an additional constraint for restraining the fixed layout element or by converting variables representing a layout element in the set of constraints into a further variable defining a virtual reference point of a particular layout entity together with a relative position within the particular layout entity of the fixed layout elements for generating a relatively fixed position. The virtual reference point of the particular layout entity may be, for example, a local origin of a sub-circuit or a cell or may be, for example, a center of gravity of the sub-circuit or cell or may be any other arbitrary point of the sub-circuit or cell. A benefit when converting the variables in the set of constraints into the constant values being the predefined position assigned to the fixed layout element is that it reduces the number of variables in the set of constraints which generally simplifies the solving of the set of constraints, generally reducing the processing time of the layout modification engine. A benefit when adding an additional constraint to the set of constraints is that the set of constraints does not need to be scanned thoroughly to identify the variables associated with the fixed layout element. This additional scanning generally requires processing time of the constraint adapter increasing the total processing time of the layout modification engine. Just adding an additional constraint in which the variable is set to the predefined position prevents the need for an additional scan through the set of constraints and thus simplifies the constraint adapter.

According to a second aspect of the invention the object is achieved with a conflict-solver as claimed in claim 11. According to a third aspect of the invention, the object is achieved with a method of modifying a circuit layout as claimed in claim 12. According to a fourth aspect of the invention, the object is achieved with a computer program product as claimed in claim 13.

### BRIEF DESCRIPTION OF THE DRAWINGS

These and other aspects of the invention are apparent from and will be elucidated with reference to the embodiments described hereinafter.

In the drawings:

FIG. 1 shows a schematic representation of layout modification engine according to the invention,

FIG. 2 shows a flowchart of a method of modifying a circuit layout according to the invention,

FIG. 3 shows a layout entity being a cell of an integrated circuit, the cell comprising a conflict,

FIG. 4 shows part of a sub-circuit of the integrated circuit comprising a further conflict, and

FIG. 5A shows a first selected area in which all layout entities within the first selected area are identified as fixed layout entities, and FIG. 5B shows a second selected area in which all layout entities outside the second selected area are identified as fixed layout entities.

The figures are purely diagrammatic and not drawn to scale. Particularly for clarity, some dimensions are exaggerated strongly. Similar components in the figures are denoted by the same reference numerals as much as possible.

### DETAILED DESCRIPTION OF THE EMBODIMENTS

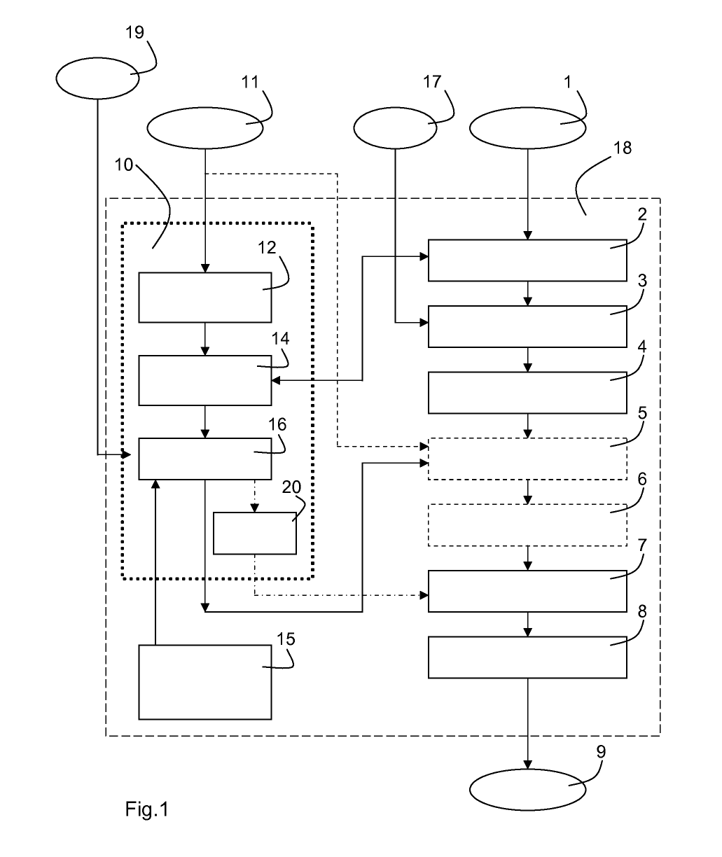

FIG. 1 shows a schematic representation of the layout modification engine 18 according to the invention. The layout modification engine 18 comprises a circuit receiver 2 for receiving a circuit layout 1, for example, being an integrated circuit. The circuit receiver 2 may, for example, be arranged to receive the circuit layout 1 in several different data-layout formats and may, for example, be arranged to convert the different data-layout formats into a specific data-layout format which is used by the remaining elements of the layout modification engine 18. The circuit receiver 2 receives the circuit layout 1 and, for example, converts the data format of the circuit layout 1 after which the circuit receiver 2 provides the circuit layout 1 to the scanner module 3. The scanner module 3 further receives the set of design-rules 17 and scans the layout entities of the circuit layout 1 for identifying groups of layout entities for which a specific design-rule 17 should be valid, identifying so called instances of design-rules 17. For example, a particular design-rule 17 may define a minimum distance between two layout entities, for example, between two polygons. The scanner module 3 scans the circuit layout 1 and identifies all instances of the particular design rule 17 by identifying groups of polygons between which the particular design rule 17 should be valid. Subsequently, the identified instances of design rule 17 together with the groups of polygons are provided to the constraint generator 4 to create a set of constraints. The set of constraints, for example, comprises equations, in which each equation comprises a mathematical representation of a design-rule 17 applied to a group of layout entities, for example, the polygons used previously. The layout modification engine 18 may, for example, comprise a free/fix scanner 5 and a constraint adapter 6 for fixing the position of the fixed layout entities in the set of constraints. The free/fix scanner 5 receives the set of constraints together with the list of fixed entities 11 and associates the variables in the set of constraints with the layout elements of the fixed entities 11. Subsequently, the constraint adapter 6 adapts the set of constraints to an adapted set of constraints in which a position of the layout elements of the fixed layout entities 11 are fixed within the set of constraints. The adapted set of constraints is subsequently solved by the solver 7 of the layout modification engine 18 and a set of instructions is provided to the layout adapter 8 for adapting the circuit layout 1 such that it complies with the set of constraints. Because the fixed layout entities 11 are included in the adapted set of constraints which are solved to generate the instructions, the fixed layout entities 11 are fixed to the predefined position. The layout modification engine 18 outputs the adapted circuit layout 9 which substantially complies with the adapted set of constraints and which may subsequently be used to manufacture the circuit layout 1 in, for example, the lithography process associated with the design-rules 17.

The layout modification engine 18 further comprises the conflict-solver 10 for solving conflicts between fixed entities 11 and free entities. The conflict-solver 10 comprises a layout analyzer 14 for analyzing the circuit layout 1 to detect a conflict between the fixed layout entity and the free layout entities. If the layout analyzer 14 identifies a conflict between the fixed layout entity and the free layout entities, the layout analyzer 14 provides the detected conflict to a conflict-solving-module 16. The conflict-solving-module 16 converts the fixed layout entity in the detected conflicts into a set of fixed layout elements. The fixed layout elements are layout elements restrained to a position. The set of fixed layout elements is generated for resolving the detected conflict.

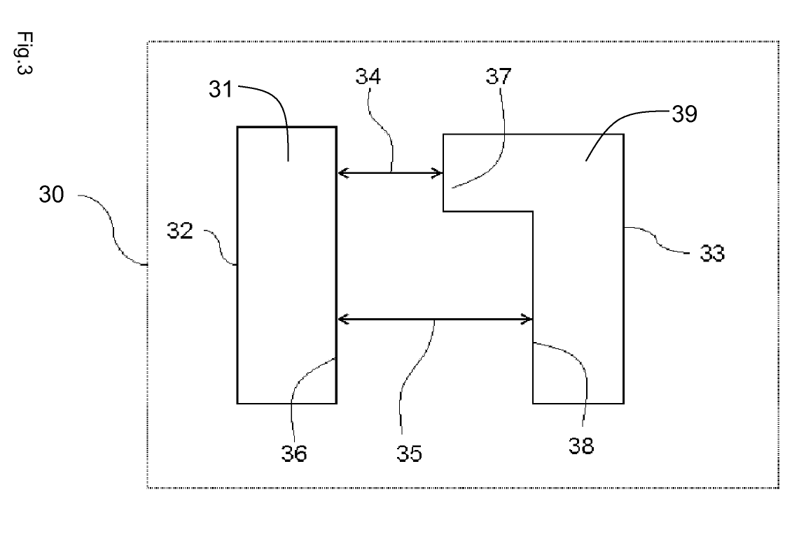

For example, if a layer 30 (see FIG. 3) is indicated as a free layout entity and a polygon 31 (see FIG. 3) within the free layer 30 is indicated as a fixed layout entity 31, the layout analyzer 14 detects the conflicting situation for the layout elements 32 and 36 (see FIG. 3) of the fixed layout entity 31 which should be fixed according to the fixed layout entity 31 but which are located in the free layer 30. These detected conflicts are subsequently provided to the conflict-solving-module 16 which, for example, request feedback from a user for solving the conflicting situation for the layout elements 32 and 36. Alternatively, the conflict-solving-module 16 may, for example, be rule based. The rule based conflict-solving-module 16 may, for example, review additional properties of the layout entity for solving the conflict. Using, for example, the additional rule that a contact entity in a first layer of the circuit layout 1 should be in contact with a polygon entity in a neighboring layer of the circuit layout 1, may enable the conflict-solving-module 16 to resolve the conflict of the layout elements 32 and 36 (of the previous example). Alternatively, the rule based conflict-solving-module 16 may, for example, have a library of generic rules for resolving conflicts between layout entities, for example, stored in a memory-module 15. An example of such a rule may by one in which the status of the, for example, smallest layout entity is used to define the status of the conflicting layout elements. In the situation shown in FIG. 3, the polygon entity 31 is part of the layer entity 30 and thus the layer entity 30 is a larger layout entity. Applying this general rule to the current situation results in the layout elements of the polygon 31 are fixed within the free layer 30.

The conflict-solver 16 may also be arranged for receiving a priority-value 19. This priority-value 19, for example, represents a level of importance of the required fixation of the fixed layout entity 11. The use of a priority-value 19 enables the conflict-solver 10 to, for example, deviate from general rules in specific cases. For example, the general rule in which the status of the smallest layout entity is used to define the status of the conflicting layout elements may be altered by assigning a higher priority-value 19 to the larger layout entity to enforce the status of the larger layout entity to the smaller entities, thus circumventing the general rule for this specific case.

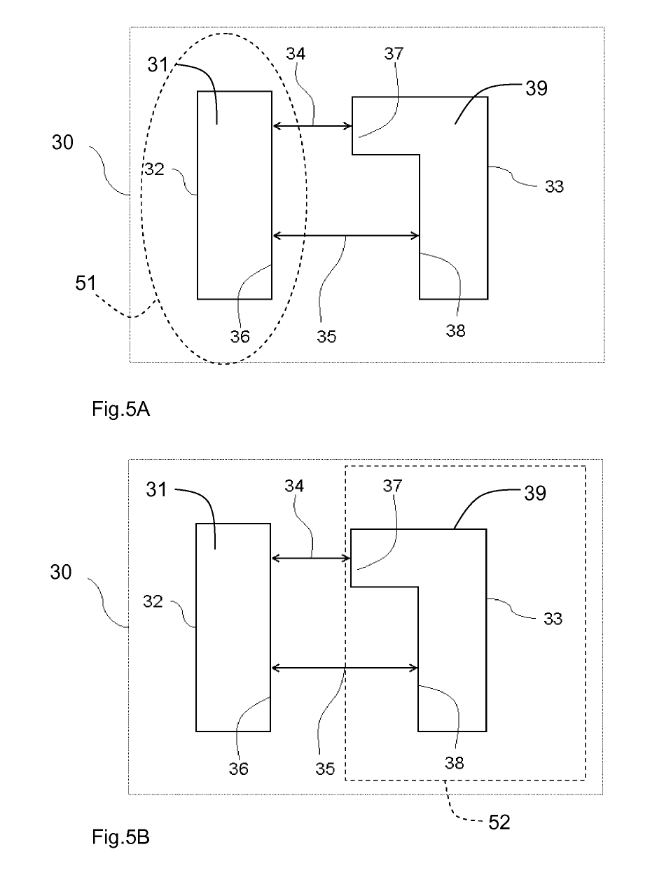

The conflict-solver 10 shown in FIG. 1 further comprises a receiver 12 for receiving the fixed layout entity. The receiver 12, for example, receives a listing of fixed layout entities 11 and/or free layout entities. Alternatively, for example, the receiver 12 may receive a selected area 51, 52 (see FIGS. 5A and 5B) indicating the fixed layout entities 11 and/or the free layout entities. The selected area 51 may, for example be drawn by a user to indicate that all entities within the selected area are fixed layout entities. Alternatively, the selected area 52 may indicate that all entities outside the selected area are fixed layout entities. The receiver 12 may also receive a label identifying a sub-circuit of the circuit layout 1. All layout entities within the sub-circuit or a selection of the layout entities of the sub-circuit may be fixed layout entities. This enables the conflict-solver 10 to only solve a conflict within a sub-circuit once and re-apply the solution every time the sub-circuit is placed within the circuit layout.

In an alternative embodiment of the conflict-solver 10, the conflict-solver 10 further comprises a constraint adapter 20. the constraint adapter 20 is arranged for fixing the position of the adapted set of fixed layout elements by adapting the set of constraints of the layout modification engine 18. For example, the constraint adapter 20 may convert variables which are associated with layout element in the set of constraints into a value representing the predefined position assigned to the fixed layout element. In this case, a relatively simple substitution of the predefined position in the set of constraints is sufficient to fix the position of the fixed layout element. However, to be able to substitute the predefined position every time the specific fixed layout element is present in the set of constraints, the constraint adapter 20 must scan through the whole set of constraints, which may be a relatively time consuming process. Alternatively, the constraint adapter 20 may, for example, fix the position of the fixed layout elements by adding an additional constraint to the set of constraints. This additional constraint restrains the position of the fixed layout element to its predefined position. This additional constraint increases the set of constraints which generally increases to processing time to find a solution to the set of constraints by the solver 7 of the layout modification engine 18. However, the constraint adapter 20 may simply add the additional constraint without having to scan through the whole set of constraints, which reduces the processing time of the constraint adapter 20.

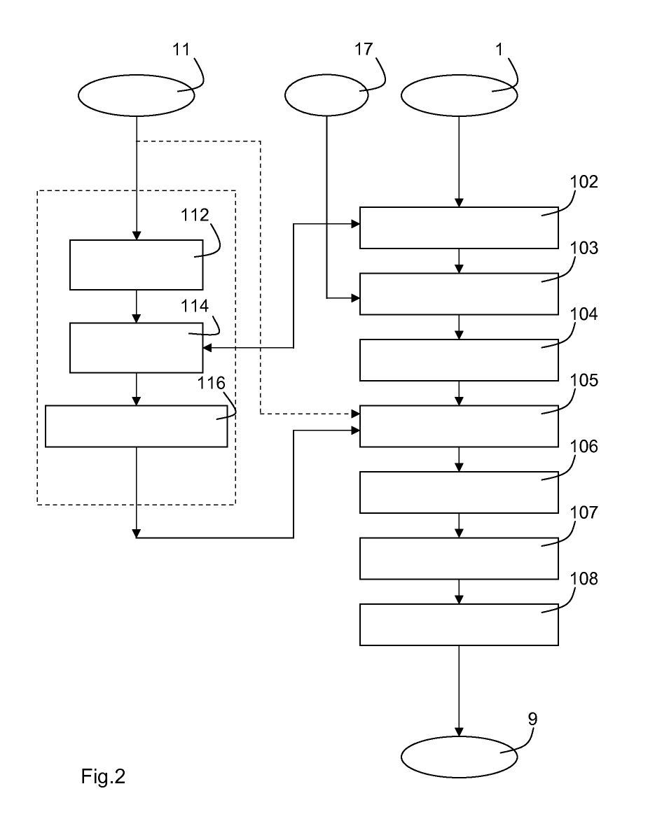

FIG. 2 shows a flowchart of a method of modifying a circuit layout 1 according to the invention. The method comprises the steps of receiving the circuit layout 102. During the step of receiving 102 the circuit layout 1, the data format of the circuit layout 1 may be converted into a preferred data format used within the layout modification engine 18 (see FIG. 1). Subsequently, the method of modifying the circuit layout 1 comprises the step of finding 103 the instances of design rules 17. During the step of finding 103 the instances of design rules 17, the method scans the layout entities of the circuit layout 1 to identify groups of layout entities for which a specific design-rule 17 should be valid. The method shown in FIG. 2 further comprises a step of generating 104 the set of constraints from the identified instances of design rules 17. Within the set of constraints, the step Match free/fix elements 105 matches the free and fixed layout elements with the variables of the constraints in the set of constraints. The set of constraints is adapted in a further step 106 for adapting the constraints in the set of constraints. This adapting of the constraints may, for example, result in adding a constraint for fixing a layout element, or may, for example, result in substituting a variable in the set of constraints representing a specific layout element which should be fixed, by a predefined value representing the location at which the fixed layout element should be restrained. The set of constraints including the adapted constraints are subsequently solved in the step solve constraints 107 which provide a set of instructions for updating the circuit layout 1 such that it substantially complies with the set of constraints. The method shown in FIG. 2 further comprises the step of updating layout 108 in which the circuit layout 1 is updated according to the instructions from the solving step 107.

The method according to the invention may further comprise the step of receiving 112 the fixed layout entity 11 and/or the free layout entities, the step of analyzing 114 the circuit layout 1 and the step of solving 116 the conflicts. During the step of receiving 112 the fixed layout entity 11 and/or the free layout entities, the method may, for example, receive a listing of the fixed layout entity 11 and/or the free layout entities. Alternatively, during the step of receiving 112, the method may, for example, receive a selected area within which all layout entities are fixed layout entities 11 or free layout entities. During the step of analyzing 114 the circuit layout 1, the circuit layout 1 is scanned for detecting a conflict between the fixed layout entity 11 and free layout entities. Finally, the method according to the invention comprises the step of solving 116 the conflict by generating a set of fixed layout elements. The fixed layout elements are layout elements restrained to a position. The set of fixed layout elements is generated for resolving the detected conflict.

FIG. 3 shows a layout entity 30 being a cell 30 of an integrated circuit 1 (see FIG. 1), in which the cell 30 comprises a conflict. For example, the cell 30 has been identified as a fixed layout entity 30. However, the layout entity 31 being a polygon 31 located within the cell 30 has been identified as a free layout entity 30. The layout elements 32, 36 of the polygon 31 have conflicting requirements in that the layout elements of the polygon 31 should be free due to the polygon 31 being a free layout entity and should be fixed due to the cell 30 being a fixed layout entity. To resolve such a conflicting situation, the conflict solver 16 (see FIG. 1) may, for example, use a general rule. Such a general rule may, for example, define that the status of the hierarchically smallest layout entity is used to define the status of the conflicting layout elements. In the current situation, the polygon 31 is part of the cell 30 and thus the cell 30 is a hierarchically larger layout entity. Applying this general rule to the current situation results in the layout elements 32, 36 of the polygon 31 being free layout elements which are free to move within the fixed cell 30.

Alternatively, the conflict solver 16 may use additional properties or requirements in deciding the status of the conflicting layout elements 32, 36. For example, the cell 30 may be labeled external Intellectual Property which may never be changed by the layout modification engine 18. This additional property would, for example, overrule the free status of the polygon 31 for resolving the conflict between the polygon 31 and the cell 30.

Alternatively, suppose that the cell 30 is identified as a free cell 30 while the layout element 36 of the polygon 31 should be a fixed layout element. If the design-rules 17 indicate that there should be a minimum distance between the polygon 31 and a further polygon 39, the constraint generator 4 (see FIG. 1) initially may generate the following equations:

x2−x1>=b

x3−x1>=b

in which x1 is a variable representing the layout element 36, x2 is a variable representing the layout element 37 and x3 is a variable representing the layout element 38. For restraining the layout element 36 to its original position, for example, 684, the constraints adapter 6, 20 (see FIG. 1) may match the number 684 to the variable x1 representing the edge 36 throughout the set of constraints. Thus the constraints adapter 6, 20 may, for example, adapt the equations shown previously into:

x2>=b+684

x3>=b+684.

Subsequently solving these equations to find possible values for x2 and x3 will always fix the position of the layout element 36 to the predefined position indicated with the number 684. Alternatively, the constraints adapter 6, 20 may add an additional constraint to the set of constraints for fixing the position of the edge 36 to the predefined position indicated with the number 684, for example, by adding the additional constraint:

x1=684.

However, the fixation of the edge 36 may also be a relative fixation within the cell 30. This relative fixation may, for example, require the edge 36 to not be moved within the cell 30 while cell 30 may be moved around within the circuit layout 1. To achieve a relative fixation, the constraint adapter 6, 20 may, for example, convert the variable x1 into a new variable comprising a virtual reference point 29 for the cell 30 together with a fixed position within cell 30. For example, the fixed position within the cell 30 may be 42, then the constraint adapter 6, 20 may convert the variable x1 into:

x1=x0+42,

wherein x0 is a variable representing the virtual reference point 29 of the cell 30.

The conflict-solver 16 may also use a priority-value to resolve the conflict between the fixed polygon 31 within the free cell 30. If, for example, a general rule is used that the status of the larger layout entity defines the status of the layout elements of the smaller layout entity, the conflicting layout elements 32 and 36 of the polygon 31 should become free layout elements. However if, for example, the polygon 31 has a higher priority-value compared to the cell 30, the conflict solver 16 may disregard the general rule and generate a set of fixed layout elements including the layout elements 32 and 36 of the polygon 31.

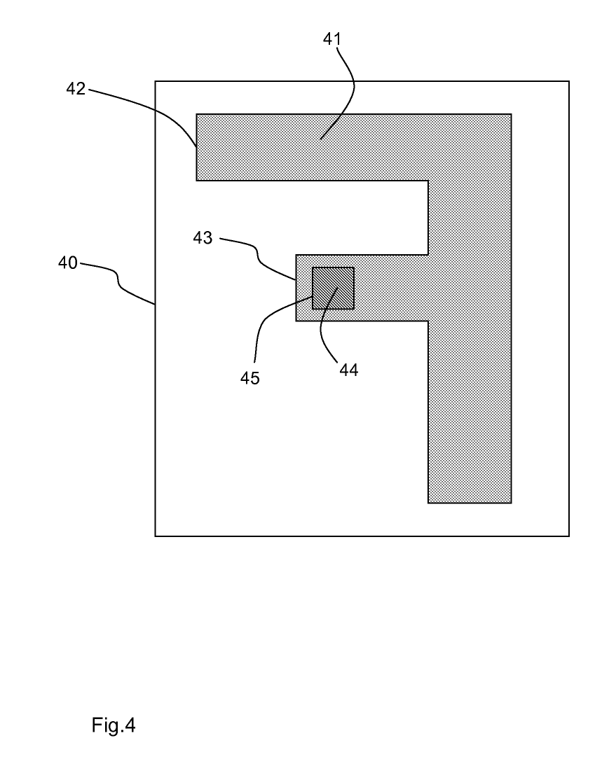

FIG. 4 shows part of a sub-circuit of the integrated circuit 1 comprising a further conflict. A first layout entity 44 shown in FIG. 4 is a contact-hole 44 comprises boundaries 45 being defined as free layout elements. A second layout entity 41 shown in FIG. 4 is a polygon 41 which comprise boundaries being fixed layout elements. The contact-hole 44 comprises, for example, an additional property in that it should be connected to the polygon 41 near an edge 43 of the polygon 41. As a result a conflict is detected between the free layout element 45 of the contact-hole 44 and the additional property forcing the contact-hole 44 to be connected to the polygon 41 near the edge 43. The conflict-solver 16 of the layout modification engine 18 according to the invention may convert the boundary 45 of the contact-hole 44 into a fixed layout element 45 and add this boundary 45 of the contact-hole 44 to the set of fixed layout elements, thus solving a conflict.

Alternatively, suppose the polygon 41 is a fixed layout entity 41 while one of the edges of the polygon 41 being the edge 43 being a free layout entity. The layout analyzer 14 detects the conflict for edge 43. Suppose the general rule is valid in which the more detailed the layout entity is, the more important its setting is, the setting of the edge 43 overrules the overall setting of the polygon 41. This means that the conflict-solving module 16 solves the conflict by generating a set fixed layout elements which comprises all edges of the polygon 41 apart from the edge 43 which is a free layout element.

FIG. 5A shows a first selected area 51 in which all layout entities 31 within the first selected area 51 are identified as fixed layout entities. FIG. 5B shows a second selected area 52 in which all layout entities 31 outside the second selected area 52 are identified as fixed layout entities. The selected areas 51, 52 may, for example, be indicated within an image representation of the circuit layout 1. The selected area 51, 52 may have any shape, such as a rectangle, circle, ellipse or polygon. The receiver 12 (see FIG. 1) receives the selected area 51, 52 and uses the selected area 51, 52 for identifying whether the layout entities should be fixed or free layout entities.

For example, in FIG. 5A the selected area includes all layout entities 31 which should be regarded by the conflict-solver 10 as fixed layout entities 31. The first selected area 51 is an ellipse. In FIG. 5B the selected area includes all layout entities 39 which should be regarded by the conflict-solver 10 as free layout entities 39. The second selected area 52 is a rectangle.

It should be noted that the above-mentioned embodiments illustrate rather than limit the invention, and that those skilled in the art will be able to design many alternative embodiments without departing from the scope of the appended claims.

Any reference to objects in layouts such as in the integrated circuit or the circuit layout may refer to polygons being defined by boundaries, paths or corners.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A layout modification engine (18) for modifying a circuit layout (1) comprising layout entities (30, 31, 39; 40, 41, 44) including a fixed layout entity (11; 31; 44) and free layout entities (30, 39; 41), the layout entities (30, 31, 39; 40, 41, 44) being a representation of at least part of an integrated circuit, each layout entity (30, 31, 39; 40, 41, 44) comprising at least one layout element (32, 36, 37, 38; 42, 43, 45), the fixed layout entity (11; 31; 44) being restrained to a predefined position and the free layout entities (30, 39; 41) being allowed to move for modifying the circuit layout (1), the layout modification engine (18) being arranged for restraining the fixed layout entity (11; 31; 44) to the predefined position while modifying the circuit layout (1) to substantially comply with a set of constraints, the set of constraints comprising design-rule-constraints for applying a design rule (17) to a group of layout elements (32, 36, 37, 38; 42, 43, 45) of the circuit layout (1),
the layout modification engine (18) comprising a conflict-solver (10) for resolving conflicts between the fixed layout entity (11; 31; 44) and the free layout entities (30, 39; 41), the conflict-solver (10) comprising:
a layout analyzer (14) for analyzing the circuit layout (1) to detect a conflict between the fixed layout entity (11; 31; 44) and the free layout entities (30, 39; 41) and for providing the detected conflicts to a conflict-solving-module (16), and
the conflict-solving-module (16) for converting the fixed layout entity (11; 31; 44) in the detected conflicts into a set of fixed layout elements (36; 43, 45), the set of fixed layout elements (36; 43, 45) being generated for resolving the detected conflict, the fixed layout elements (36; 43, 45) being layout elements restrained to a position.

2. Layout modification engine (18) as claimed in claim 1, wherein the detected conflict comprises a detected layout element (36, 43) being part of the fixed layout entity (11; 31; 44) and being part of a free layout entity (30, 39; 41).

3. Layout modification engine (18) as claimed in claim 1, wherein the conflict-solving-module (16) is rule-based.

4. Layout modification engine (18) as claimed in claim 1, wherein the conflict-solving-module (16) includes:
using additional properties of the fixed layout entity (11; 31; 44) for resolving the detected conflict, and/or
using a generic rule for resolving the detected conflict.

5. Layout modification engine (18) as claimed in claim 1, wherein the conflict-solving-module (16) is arranged for receiving a priority-value (19) representing a level of importance of the required fixation of the fixed layout entity (11; 31; 44).

6. Layout modification engine (18) as claimed in claim 1, wherein the conflict-solver (10) further comprises a receiver (12) for receiving the fixed layout entity (11; 31; 44) and/or for receiving the free layout entities (30, 39; 41).

7. Layout modification engine (18) as claimed in claim 6, wherein the fixed layout entity (31) is a relatively fixed layout entity (31) being a layout entity restrained relative to a virtual reference point (29), the virtual reference point (29) being a further fixed layout entity or a further free layout entity.

8. Layout modification engine (18) as claimed in claim 6, wherein the receiver (12) is arranged for receiving the fixed layout entity (11; 31; 44) and/or for receiving the free layout entities (30, 39; 41) via:
a listing of fixed and/or free layout entities (30, 31, 39; 40, 41, 44), and/or
a selected area (51, 52), all layout entities (31) within the selected area (51) being fixed layout entities (31) or all layout entities (31) outside the selected area (52) are fixed layout entities (31), and/or
a label of a sub-circuit within the circuit layout (1), all layout entities (44) within the sub-circuit or a selection of the layout entities of the sub-circuit being fixed layout entities (44) or free layout entities (41).

9. Layout modification engine (18) as claimed in claim 1, wherein the conflict-solver (10) further comprises a constraint adapter (20) for adapting the set of constraints to fix a position of the set of fixed layout elements (36; 43, 45).

10. Layout modification engine (18) as claimed in claim 9, wherein the constraint adapter (20) is arranged for fixing the position of the adapted set of fixed layout elements (36; 43, 45) via:
converting variables representing a layout element (32, 36, 37, 38; 42, 43, 45) in the set of constraints into constant values representing the predefined position assigned to the fixed layout element (36; 43, 45), or
adding an additional constraint for restraining the fixed layout element (36; 43, 45), or
converting variables representing a layout element (32, 36, 37, 38; 42, 43, 45) in the set of constraints into a further variable defining a virtual reference point (29) of a particular layout entity (30) together with a relative position within the particular layout entity (30) of the fixed layout elements (36) for generating a relatively fixed position.

11. A conflict-solver (10) for use in a layout modification engine (18) as claimed in claim 1, the layout modification engine (18) being arranged for modifying a circuit layout (1) comprising layout entities (30, 31, 39; 40, 41, 44) including a fixed layout entity (11; 31; 44) and free layout entities (30, 39; 41), the conflict-solver (10) being arranged for resolving conflicts between the fixed layout entity (11; 31; 44) and the free layout entities (30, 39; 41), the conflict-solver (10) comprising:
a layout analyzer (14) for analyzing the circuit layout (1) to detect a conflict between the fixed layout entity (11; 31; 44) and the free layout entities (30, 39; 41) and for providing the detected conflicts to a conflict-solving-module (16), and
the conflict-solving-module (16) for converting the fixed layout entity (11; 31; 44) in the detected conflicts into a set of fixed layout elements (36; 43, 45), the set of fixed layout elements (36; 43, 45) being generated for resolving the detected conflict, the fixed layout elements (36; 43, 45) being layout elements restrained to a position.

12. A method (110) of modifying a circuit layout (1) comprising layout entities (30, 31, 39; 40, 41, 44) including a fixed layout entity (11; 31; 44) and free layout entities (30, 39; 41), the layout entities (30, 31, 39; 40, 41, 44) being a representation of at least part of an integrated circuit, each layout entity (30, 31, 39; 40, 41, 44) comprising at least one layout element (32, 36, 37, 38; 42, 43, 45), the fixed layout entity (11; 31; 44) being restrained to a predefined position and the free layout entities (30, 39; 41) being allowed to move for modifying the circuit layout (1), the method (110) being arranged for restraining the fixed layout entity (11; 31; 44) to the predefined position while modifying the circuit layout (1) to substantially comply with a set of constraints, the set of constraints comprising design-rule-constraints for applying a design rule (17) to a group of layout elements (32, 36, 37, 38; 42, 43, 45) of the circuit layout (1),
the method comprising the steps of:
analyzing (114) the circuit layout (1) for detecting a conflict between the fixed layout entity (11; 31; 44) and free layout entities (30, 39; 41),
if a conflict is detected, the method further comprising the steps of:
solving (116) the conflict by generating (116) a set of fixed layout elements (36; 43, 45), the fixed layout elements (36; 43, 45) being layout elements restrained to a position.

13. A computer program product arranged to perform the method as claimed in claim 12.
